(19) United States
(12) Patent Application Publication
(10) Pub. No.: US 2023/0010909 A1
(43) Pub. Date: Jan. 12, 2023

(54) MODULAR PLANTING MATERIAL FOR NATURAL TURF IN SPORTS FIELD AND ITS MANUFACTURING PROCESS

(71) Applicants: CHIEN CHIA CHEN, TAOYUAN CITY (TW); CHUNG PING KUO, TAIPEI CITY (TW); FENG SHENG YUAN, KEELUNG CITY (TW)

(72) Inventors: CHIEN CHIA CHEN, TAOYUAN CITY (TW); CHUNG PING KUO, TAIPEI CITY (TW); FENG SHENG YUAN, KEELUNG CITY (TW)

(21) Appl. No.: 17/371,562

(22) Filed: Jul. 9, 2021

(51) Int. Cl. A01G 20/20; A01G 24/12; A01G 24/22

(52) U.S. Cl. CPC A01G 20/20; A01G 24/12; A01G 24/22; A63B 69/3691

(57) ABSTRACT

A modular planting material for natural turf in sports field and its manufacturing process, the material is consist of a far-infrared mineral substrate, a multi-biochar, and a polysaccharide polymer; wherein the far-infrared mineral substrate is composed of SiO2, ZnO, CaO, Al2O3, Fe2O3, K2O, MgO, TiO2, CeO2, La2O3, pulverized fuel ash 1, and raw carbon powder; the multi-biochar is composed of rice husk, oil millet husk, and oil millet stalk; the polysaccharide polymer is composed of polyuronic acid, sodium salt, and cellulose; The present invention let 75˜85% far-infrared mineral substrate, 10-20% multi-biochar, and 2˜5% polysaccharide polymer be mixed, stirred, dried, heated and pressed into shape, high temperature sterilized and molded, and cooled and pressed, then cut to form a natural turf modular planting material. Since the modular planting material has many pores, it has the feature of water retention, air permeability and promoting the growth of the beneficial bacteria and the plants.

### BACKGROUND OF THE INVENTION

1. Field of the Invention

The present invention relates to a modular planting material especially the one relates to a modular planting material for natural turf in sports field and its manufacturing process that having far-infrared mineral substrate as main component.

2. Description of the Related Art

Generally, the soil for planting will evolve from the original soft elasticity into a firm condition after a period of time due to the withering of the plant roots or insect pests, as well as the rain and artificial stepping, which will affect the extension ability of the plant roots in the soil, and further causes plants to wither or grow poorly.

The vast and green turf of the golf course is an element that attracts people to play golf. Therefore, the optimization of the soil of the golf course and the prevention of yellowing of the turf have become an important issue for the maintenance of the turf of the golf course. In the past, golf courses used special scarifier, which was pulled by a tractor to loosen the soil; this kind of loosening soil similar to the excavation type would firstly cause the turf to be broken, and secondly, the soil loss would also be extremely large. Furthermore, the excavated soil surface also needs to be recuperated for a period of time before it can be used or stepped on; therefore, the application of turning the soil to maintain the turf often results in the closure of the fairway and even seriously affects the operation of the course.

Referring to FIG. 1, is a kind of soil improvement structure. Many golf courses use this structure to fundamentally solve the problem of constantly turning the soil for turf maintenance; in the diagram, the structure includes a bottommost foundation layer 910, and the stack above it is followed by a gravel layer 920, a drainage layer 930, a resin layer 940, and a natural turf 950; and the gravel layer 920 is embedded with multiple drainage pipes 961, and the resin layer 940 is embedded with multiple heating pipes 962; Since the structure can avoid hard soil caused by human stepping, as shown in FIG. 1B, the roots 951 of the natural turf 950 of the course can be fully extended in the resin layer 940, so the turf presents a vigorous scene.

However, the golf course occupies a large area. If the above-mentioned structure is comprehensively constructed, it will not only be a huge project, but also costly. Furthermore, the inventor has recently developed a multi-element and high-performance far-infrared mineral substrate, which has a porous structure with the feature of (1) Can breed probiotics (2) Increase soil oxygen content (3) Improve soil drainage and water retention (4) Improve soil compaction and hardening (5) Balance microbes (6) Accelerate plant growth, enhance plant vitality, etc. It is very suitable to be soil improvement agent;

therefore, how to further apply the far-infrared mineral substrate to the golf course as the main component of the turf soil to reduce the cost of course construction and improve the cumbersome maintenance of turf has become the inventor's subject.

### SUMMARY OF THE INVENTION

A primary objective of the present invention is to provide a modular planting material for natural turf that use far-infrared mineral substrate as main component, and making it porous, so it can be implanted in the soil to provide a water-retaining function, and promote the growth of plants.

Another objective of the present invention is to provide a modular planting material for natural turf in sports field and its manufacturing process, the modular planting material of the natural turf can be quickly and widely laid on the sports field, reducing the cost of stadium construction, improving the tedious work of turf maintenance, and forming a green and environmentally friendly circular chain.

To achieve the objective mentioned above, the material is consist of a far-infrared mineral substrate, a multi-biochar, and a polysaccharide polymer; wherein the far-infrared mineral substrate, its composition and weight percentage is: silicon dioxide (SiO2) 35˜58%, zinc oxide (ZnO) 1˜5%, calcium oxide (CaO) 3˜10%, alumina (Al2O3) 3˜5%, iron oxide (Fe2O3) 10˜20%, potassium oxide (K2O) 3˜5%, magnesium oxide (MgO) 1˜3%, titanium dioxide (TiO2) 1˜5%, pulverized fuel ash 14˜30%, raw carbon powder 5˜10%, cerium oxide (CeO2) 0.5˜1%, and lanthanum oxide (La2O3) 0.1˜0.5%; the composition is mixed, positioned and shaped, and then calcined at high temperature to form a porous structure, the porous structure has pore diameter of 0.2˜0.8 microns, PH6.5˜8.5, density of 0.4˜0.6 g/ml, specific surface area of 80-100 m²/g, and far-infrared emissivity more than 86%; the composition and weight percentage of the multi-biochar is rice husk 60˜80%, oil millet husk 10˜30%, and oil millet stalk 5˜15%; the composition must be dried before being fumigated and pyrolyzed to make multi-biochar; the polysaccharide polymer includes polyuronic acid, sodium salt, and cellulose, and they are used to improve consistency, stability, disintegration, and water retention properties; and after 75˜85% far-infrared mineral substrate, 10-20% multi-biochar, and 2˜5% polysaccharide polymer are mixed, stirred, dried, heated and pressed into shape, high temperature sterilized and molded, and cooled and pressed, then cut into a sheet form natural turf modular planting material.

Also, the best composition and weight percentage of far-infrared mineral substrate is: silicon dioxide (SiO2) 50˜51%, zinc oxide (ZnO) 1˜1.5%, calcium oxide (CaO) 3%, alumina (Al2O3) 4˜5%, iron oxide (Fe2O3) 14.8˜15%, potassium oxide (K2O) 3˜3.5%, magnesium oxide (MgO) 1%, titanium dioxide (TiO2) 1˜1.5%, pulverized fuel ash 14˜15%, raw carbon powder 5%, cerium oxide (CeO2) 0.6˜0.7%, and lanthanum oxide (La2O3) 0.1%; the composition is mixed, positioned and shaped, and then calcined at high temperature to form a porous structure, and the far-infrared emissivity of the porous structure is more than 94%.

Also, the rice husk has components including nitrogen, phosphorus, potassium, calcium, magnesium, and silicon; and the oil millet husk has components including fat, protein, zinc, calcium, magnesium, potassium, and amino acids; and the oil millet stalk has components including lignocellulose and fatty acids.

Also, the manufacturing method of the far-infrared mineral substrate is completed through the following steps according to the composition ratio of the far-infrared mineral substrate, including: a) Preliminary screening: Preliminary screening of the raw materials of the mineral soil of the composition; b) Crushing: Crushing equipment is used to make the mineral material of the composition into powder; c) Screening: Use screening equipment to screen the above-mentioned powders to a suitable particle size; d) Composition preparation: Prepare the composition of the appropriate particle size according to the required ratio; e) Proportional mixing: Use mixing equipment to stir the composition to form a mixture; f) Positioning and shaping: Use shaping equipment to press the above-mentioned mixture to form a blank; g) Precise calcination: Use a calcination furnace to heat the above-mentioned blank to a temperature of 1000˜1360° C., so that the sticky effect of the aluminum element is eliminated, thereby forming a porous structure; h) High-energy test: Use test equipment to measure the above-mentioned porous structure to ensure that it has a pore size of 0.2˜0.8 microns, PH6.5˜8.5, density 0.4˜0.6 g/ml, specific surface area 80˜100 M²/g, and the far-infrared emissivity is above 86%; i) Classification and crushing: Use crushing equipment to make the porous structure which passed the test into powder; and j) Nano-grinding: Use dry-type nano-grinding equipment to grind the above-mentioned powders into specifications (0.85 mm to nanometer level) to make multiple high-efficiency far-infrared mineral substrates.

Also, the manufacturing method of the multi-biochar is completed by the following steps according to the composition ratio of the multi-biochar, including: a) Vibration feeding and screening: Use vibration equipment and screen to screen the composition, and stir the composition according to the required ratio to form a mixture; b) Preheating: Use a preheating device to raise the mixture to a temperature of 100˜120° C. and dry it to ensure the uniformity of quality; c) Fumigation and pyrolysis: Use a rotary sintering furnace to further heat the mixture to a temperature of 250˜700° C. to avoid extreme carbonization that change its due physical, chemical, and biological diversification effects; d) Cooling: Place the mixture in the air to cool it down to room temperature; and e) Crushing, grinding, and classifying: Use crushing equipment to make the above-mentioned mixture at room temperature into powder, and use grinding equipment to grind the powder, and then classifying different specifications of multi-biochar finished product with different mesh screens.

Also, the manufacturing method is to complete the 75-85% far-infrared mineral substrate, 10-20% multi-biochar, and 2-5% polysaccharide polymer through the following steps, including: a) Stirring and conveying: Mix the aforementioned three materials according to their proportions, and use a stirring tank to fully stir, and then convey the mixture to the next process with a conveyor belt; b) Drying: Use a hot air stove to dry the aforementioned mixture;

c) Pressing and shaping: Put the aforementioned dried mixture in a mold and heat it to a temperature of 80° C., then press and shape it to form a semi-finished product; d) Sterilization and molding: Use a dry stove to heat the semi-finished product after pressing to a temperature of 100° C. for high-temperature sterilization and molding, so that the semi-finished product achieves uniformity, water retention, and stability; e) Cooling and pressing: Place the aforementioned sterilized and formed semi-finished product in the air to cool it to room temperature, and apply a mold for pressing to form a finished product; and f) Cutting: Use a cutting machine to cut the aforementioned finished product into modular planting materials.

The present invention, a modular planting material for natural turf in sports field and its manufacturing process, let 75˜85% far-infrared mineral substrate, 10-20% multi-biochar, and 2-5% polysaccharide polymer be mixed, stirred, dried, heated and pressed into shape, high temperature sterilized and molded, and cooled and pressed, then cut into a sheet form natural turf modular planting material, so as to have below feature: 1) It can make the soil layer have drainage, moisture retention, heat preservation, and insect repellent; (2) It can prevent soil acidification and plate formation; (3) Contribute to the growth of beneficial bacteria; (4) Improve the soil so as to enhance the growth of turf; (5) Reduce the cost of the construction and maintenance of the natural lawn of the sports field.

### BRIEF DESCRIPTION OF THE DRAWINGS

FIGS. 1A˜1B is a schematic diagram illustrating the turf soil structure of the golf course of the prior art.

FIG. 2 is a block diagram illustrating the steps of the far-infrared mineral substrate manufacturing process.

FIG. 3 is a block diagram illustrating the steps of the multi-biochar manufacturing process.

FIG. 4 is a block diagram illustrating the steps of the manufacturing process of the present invention manufacturing process.

FIG. 5 is a schematic diagram of the manufacturing process of the present invention manufacturing process.

FIG. 6A is a schematic diagram of the finished product of the sheet form modular planting material of the present invention.

FIG. 6B is a schematic diagram of the finished product of the roll form modular planting material of the present invention.

FIG. 7 is a schematic diagram illustrating the application of the present invention on the turf soil structure of the sports ground.

FIG. 8 is a schematic diagram illustrating the application of the present invention on the turf soil structure of the golf course.

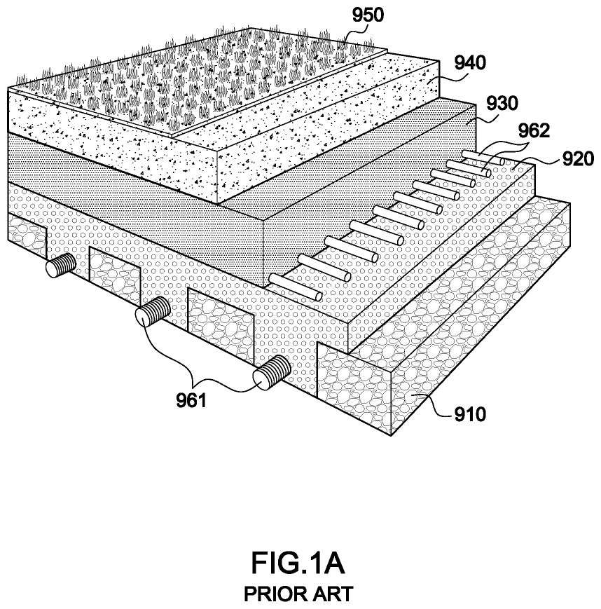

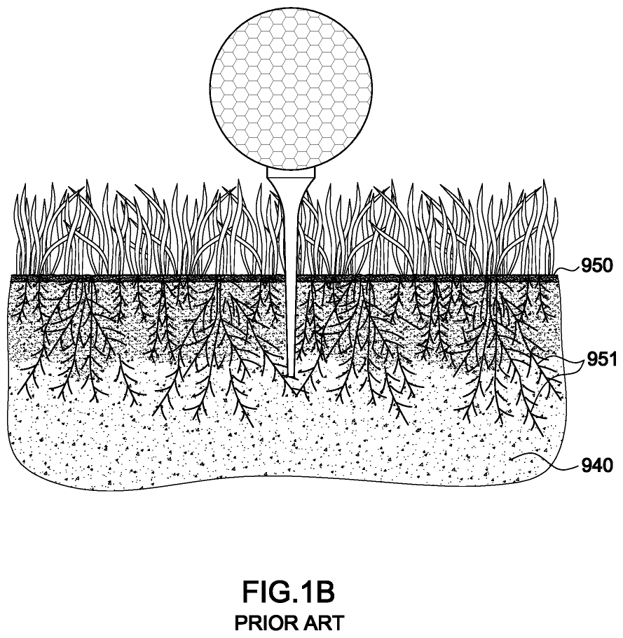

### DETAILED DESCRIPTION OF THE PREFERRED EMBODIMENT

The following is a specific embodiment to illustrate the implementation of the present invention. Those skilled in the art can easily understand the other advantages and effects of the present invention from the content disclosed in this specification. The present invention can also be implemented or applied by other different specific embodiments, and various details in this specification can also have various modifications and changes that can be made without departing from the spirit of the present invention based on different viewpoints and applications. In addition, the following sports fields mentioned in the present invention include golf courses, football fields, and other sports fields.

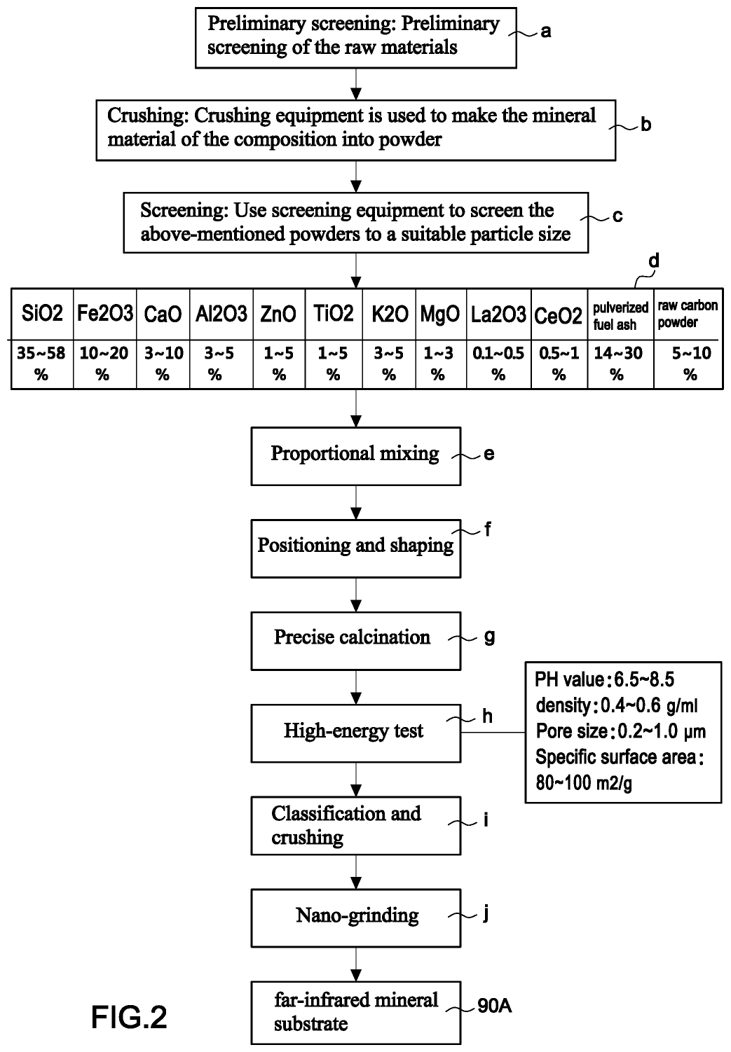

Referring to FIG. 2, the present invention the manufacturing method of the far-infrared mineral substrate 90A in the present invention disclose a preferred embodiment of modular planting material for natural turf in sports field, including:

a) Preliminary screening: Preliminary screening of the raw materials of the mineral soil of the composition;

b) Crushing: Crushing equipment is used to make the mineral material of the composition into powder;

c) Screening: Use screening equipment to screen the above-mentioned powders to a suitable particle size;

d) Composition preparation: Prepare the composition of the appropriate particle size according to the required ratio;

e) Proportional mixing: Use mixing equipment to stir the composition to form a mixture;

f) Positioning and shaping: Use shaping equipment to press the above-mentioned mixture to form a blank;

g) Precise calcination: Use a calcination furnace to heat the above-mentioned blank to a temperature of 1000˜1360° C., so that the sticky effect of the aluminum element is eliminated, thereby forming a porous structure;

h) High-energy test: Use test equipment to measure the above-mentioned porous structure to ensure that achieving the effect of qualitative and quantitative;

i) Classification and crushing: Use crushing equipment to make the porous structure which passed the test into powder; and

j) Nano-grinding: Use dry-type nano-grinding equipment to grind the above-mentioned powders into specifications (0.85 mm to nanometer level) required to make multiple high-efficiency far-infrared mineral substrates.

Also, in the step d) aforementioned, during composition preparation, the composition contains a number of oxidized inorganic substances that can produce far-infrared wavelengths, rare earth elements with the wavelength of life light, and pulverized fuel ash and raw carbon powder with porous holes to increase drainage, water retention, air permeability and adhesion; and the far-infrared mineral substrate 90A of the present invention, its composition and weight percentage is: silicon dioxide (SiO2) 35˜58%, zinc oxide (ZnO) 1˜5%, calcium oxide (CaO) 3˜10%, alumina (Al2O3) 3˜5%, iron oxide (Fe2O3) 10˜20%, potassium oxide (K2O) 3˜5%, magnesium oxide (MgO) 1˜3%, titanium dioxide (TiO2) 1˜5%, pulverized fuel ash 14˜30%, raw carbon powder 5˜10%, cerium oxide (CeO2) 0.5˜1%, and lanthanum oxide (La2O3) 0.1˜0.5%; moreover, the high-energy test in the step h) aforementioned can ensure the present invention achieving pore diameter of 0.2˜0.8 microns, PH6.5˜8.5, density of 0.4˜0.6 g/ml, specific surface area of 80-100 m²/g, and far-infrared emissivity more than 86%.

In the present invention, according to the Design of Experiments, the composition of the far-infrared mineral substrate 90A is mixed into multiple groups of substrates with different proportions according to different weight percentages, and after positioning and shaping, 1000˜1360° C. precise calcination, and then test again to select the two groups with the highest emissivity; the composition ratio of one of them is: silicon dioxide (SiO2) 50%, zinc oxide (ZnO) 1.5%, calcium oxide (CaO) 3%, alumina (Al2O3) 5%, iron oxide (Fe2O3) 14.8%, potassium oxide (K2O) 3%, magnesium oxide (MgO) 1%, titanium dioxide (TiO2) 1%, pulverized fuel ash 15%, raw carbon powder 5%, cerium oxide (CeO2) 0.6%, and lanthanum oxide (La2O3) 0.1%, and the far-infrared emissivity is 95.2%; the composition ratio of another of them is: silicon dioxide (SiO2) 51%, zinc oxide (ZnO) 1%, calcium oxide (CaO) 3%, alumina (Al2O3) 4.2%, iron oxide (Fe2O3) 15%, potassium oxide (K2O) 3.5%, magnesium oxide (MgO) 1%, titanium dioxide (TiO2) 1.5%, pulverized fuel ash 14%, raw carbon powder 5%, cerium oxide (CeO2) 0.7%, and lanthanum oxide (La2O3) 0.1%, and the far-infrared emissivity is 95.2%; Moreover, from the composition ratios of the above two, the optimal weight percentage of the composition is: silicon dioxide (SiO2) 50˜51%, zinc oxide (ZnO) 1˜1.5%, calcium oxide (CaO) 3%, alumina (Al2O3) 4.2˜5%, iron oxide (Fe2O3) 14.8˜15%, potassium oxide (K2O) 3˜3.5%, magnesium oxide (MgO) 1%, titanium dioxide (TiO2) 1˜1.5%, pulverized fuel ash 14˜15%, raw carbon powder 5%, cerium oxide (CeO2) 0.6˜0.7%, and lanthanum oxide (La2O3) 0.1%; the composition is mixed, positioned and shaped, and then calcined at high temperature to form a porous structure, and the far-infrared emissivity of the porous structure is more than 94%.

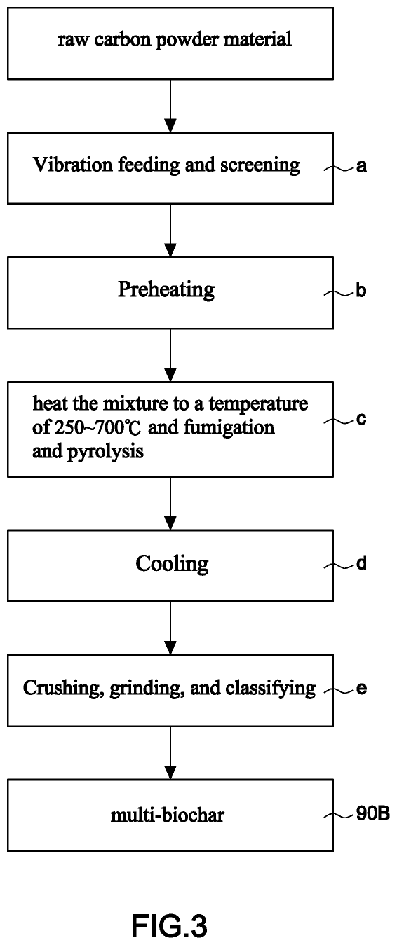

Referring to FIG. 3, the manufacturing process of the multi-biochar 90B, including: a) Vibration feeding and screening: Use vibration equipment and screen to screen the composition, and stir the composition according to the required ratio to form a mixture; b) Preheating: Use a preheating device to raise the mixture to a temperature of 100˜120° C. and dry it to ensure the uniformity of quality; c) Fumigation and pyrolysis: Use a rotary sintering furnace to further heat the mixture to a temperature of 250˜700° C. to avoid extreme carbonization that change its due physical, chemical, and biological diversification effects; d) Cooling: Place the mixture in the air to cool it down to room temperature; and e) Crushing, grinding, and classifying: Use crushing equipment to make the above-mentioned mixture at room temperature into powder, and use grinding equipment to grind the powder, and then classifying different specifications of multi-biochar finished product with different mesh screens. Moreover, the composition and weight percentage in the aforementioned step a) is: rice husk 60˜80%, oil millet husk 10˜30%, and oil millet stalk 5˜15%; wherein, the rice husk has components including nitrogen, phosphorus, potassium, calcium, magnesium, and silicon; and the oil millet husk has components including fat, protein, zinc, calcium, magnesium, potassium, and amino acids; and the oil millet stalk has components including lignocellulose and fatty acids.

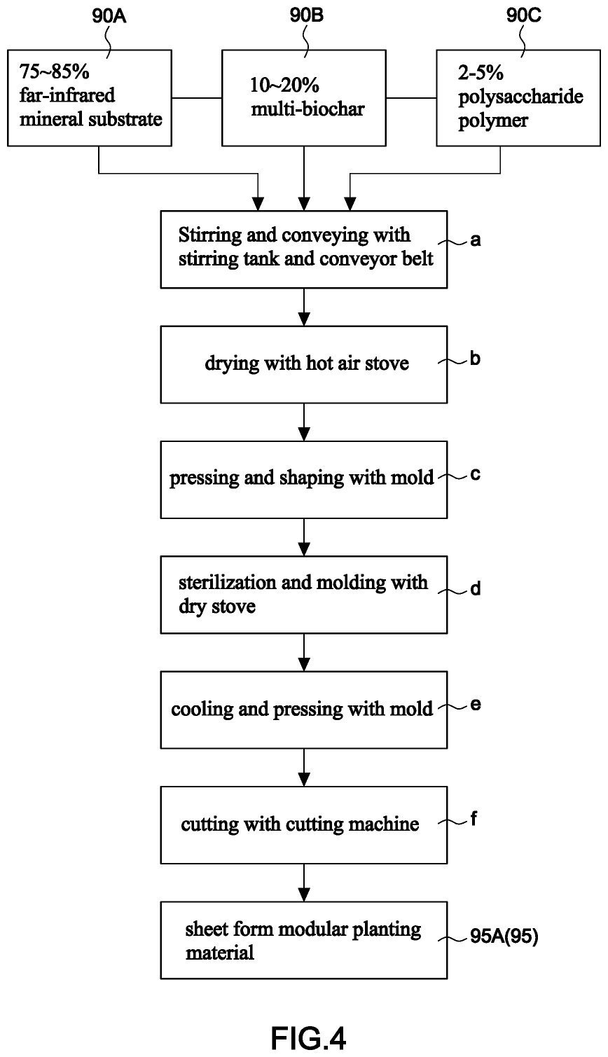

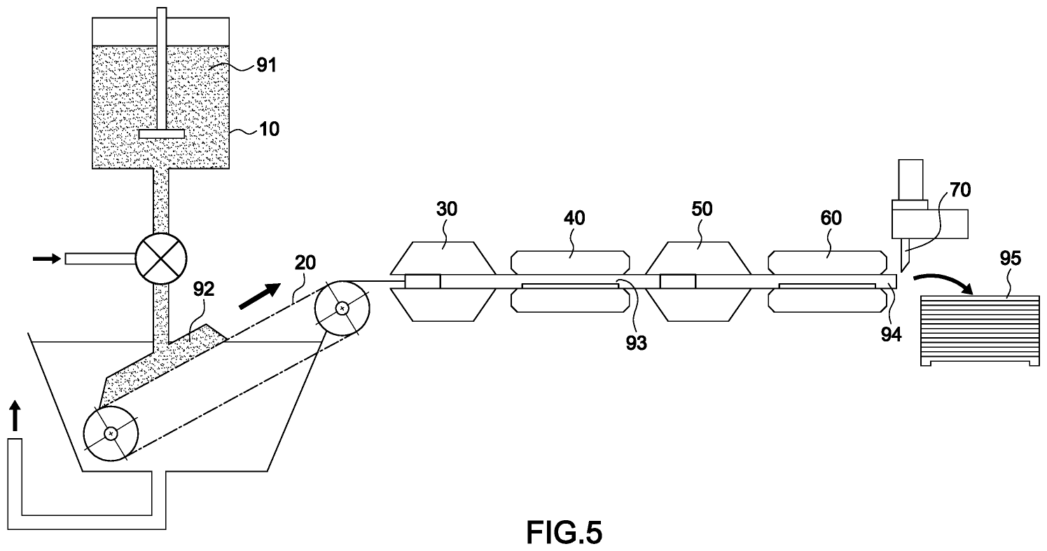

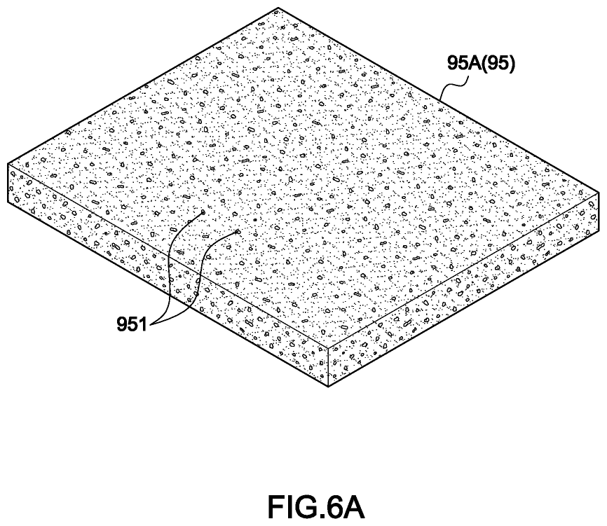

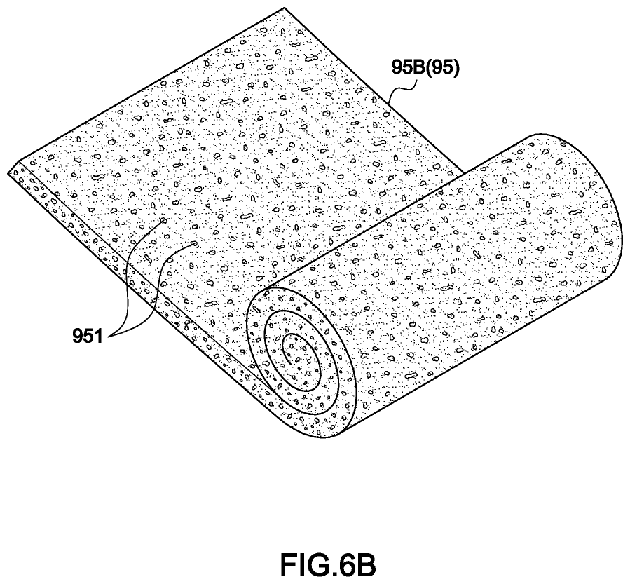

Referring to FIGS. 4-5, the manufacturing method is to complete the 75-85% far-infrared mineral substrate 90A, 10-20% multi-biochar 90B, and 2-5% polysaccharide polymer 90C through the following steps, including: a) Stirring and conveying: Mix the aforementioned three materials 91 according to their proportions, and use a stirring tank 10 to fully stir, and then convey the mixture 92 to the next process with a conveyor belt 20; b) Drying: Use a hot air stove 30 to dry the aforementioned mixture 92; c) Pressing and shaping: Put the aforementioned dried mixture 92 in a mold 40 and heat it to a temperature of 80° C., then press and shape it to form a semi-finished product 93; d) Sterilization and molding: Use a dry stove 50 to heat the semi-finished product 93 after pressing to a temperature of 100° C. for high-temperature sterilization and molding, so that the semi-finished product 93 achieves uniformity, water retention, and stability; e) Cooling and pressing: Place the aforementioned sterilized and formed semi-finished product 93 in the air to cool it to room temperature, and apply a mold 60 for pressing to form a finished product 94; and f) Cutting: Use a cutting machine 70 to cut the finished product 94 into modular planting materials 95, including a sheet form modular planting material 95A, as FIG. 6A showing, or a roll form modular planting material 95B, as FIG. 6B showing; moreover, it can be seen from the drawing that the structure has many pores 951, and the porous structure promotes the modular planting material 95 to have the characteristics of high far-infrared emissivity.

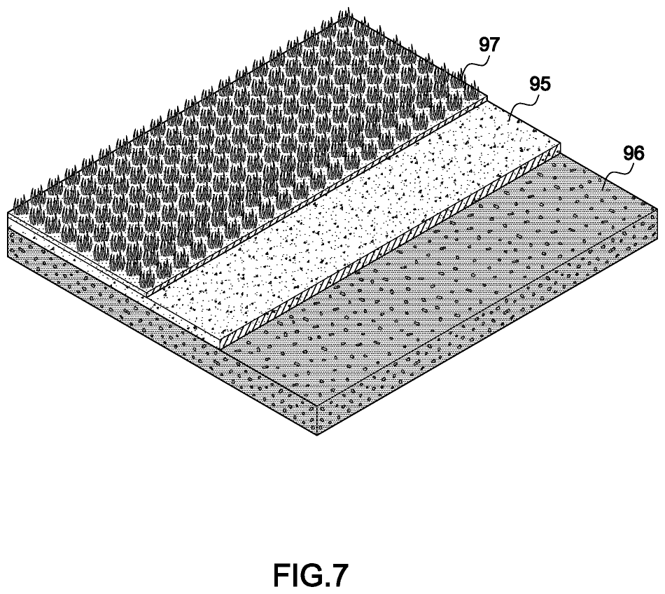

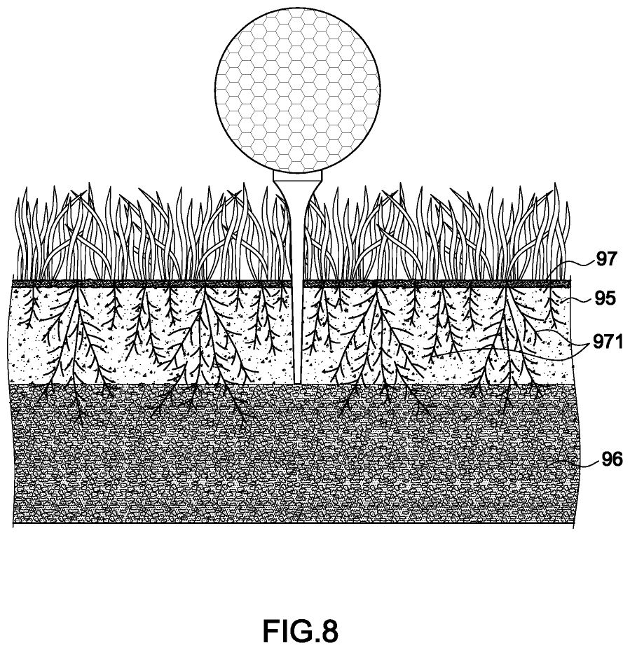

Referring to FIGS. 7-8, the drawing is illustrating the status of the modular planting material 95 while applying to the sport field to form a nature turf; wherein, the modular planting material 95 can be sheet form 95A or roll form, 95B, it is arranged on top of a soil layer 96, and the soil layer 96 needs to be plowed and loosened first, and finally the turf layer 97 is arranged on top of the modular planting material 95; Since the modular planting material 95 has many pores 951, it has the feature of water retention, air permeability and promoting the growth of plants; the roots 971 of the turf layer 97 can be fully extended in the modular planting material 95, so the turf presents a vigorous scene, as FIG. 8 showing.

The present invention, modular planting material for natural turf in sports field, let 75˜85% far-infrared mineral substrate 90A, 10-20% multi-biochar 90B, and 2˜5% polysaccharide polymer 90C be mixed, stirred, dried, heated and pressed into shape, high temperature sterilized and molded, and cooled and pressed, then cut into a sheet form natural turf modular planting material 95A and a roll form natural turf modular planting material 95B, which having below feature: 1) It can make the soil layer have drainage, moisture retention, heat preservation, and insect repellent; (2) It can prevent soil acidification and plate formation; (3) Contribute to the growth of beneficial bacteria; (4) Improve the soil so as to enhance the growth of turf; (5) Reduce the cost of the construction and maintenance of the natural lawn of the sports field; and finally the turf layer 97 is arranged on top of the modular planting material 95, so the roots 971 of the turf layer 97 can be fully extended in the modular planting material 95, so the turf presents a vigorous scene; therefore, whether it is a golf course, a football field, or other sports venues, the soil will be transformed accordingly, effectively reducing the cost of construction and maintenance of the natural turf of the sports venue, thereby forming a green and environmentally friendly circular chain.

Although particular embodiments of the invention have been described in detail for purposes of illustration, various modifications and enhancements may be made without departing from the spirit and scope of the invention. Accordingly, the invention is not to be limited except as by the appended claims

What is claimed is:

1. A modular planting material for natural turf in sports field and its manufacturing process, the material is consist of a far-infrared mineral substrate, a multi-biochar, and a polysaccharide polymer; wherein the far-infrared mineral substrate, its composition and weight percentage is:
silicon dioxide (SiO2) 35˜58%, zinc oxide (ZnO) 1˜5%, calcium oxide (CaO) 3˜10%, alumina (Al2O3) 3˜5%, iron oxide (Fe2O3) 10˜20%, potassium oxide (K2O) 3˜5%, magnesium oxide (MgO) 1˜3%, titanium dioxide (TiO2) 1˜5%, pulverized fuel ash 14˜30%, raw carbon powder 5˜10%, cerium oxide (CeO2) 0.5˜1%, and lanthanum oxide (La2O3) 0.1˜0.5%; the composition is mixed, positioned and shaped, and then calcined at high temperature to form a porous structure, the porous structure has pore diameter of 0.2˜0.8 microns, PH6.5˜8.5, density of 0.4˜0.6 g/ml, specific surface area of 80-100 m²/g, and far-infrared emissivity more than 86%;
the composition and weight percentage of the multi-biochar is: rice husk 60˜80%, oil millet husk 10˜30%, and oil millet stalk 5˜15%; the composition must be dried before being fumigated and pyrolyzed to make the multi-biochar;
the polysaccharide polymer includes polyuronic acid, sodium salt, and cellulose, and they are used to improve consistency, stability, disintegration, and water retention properties; and
after 75˜85% far-infrared mineral substrate, 10-20% multi-biochar, and 2˜5% polysaccharide polymer are mixed, stirred, dried, heated and pressed into shape, high temperature sterilized and molded, and cooled and pressed, then cut into a sheet form natural turf modular planting material.

2. The Modular planting material for natural turf in sports field and its manufacturing process as claimed in claim 1, wherein the best composition and weight percentage of far-infrared mineral substrate is: silicon dioxide (SiO2) 50˜51%, zinc oxide (ZnO) 1˜1.5%, calcium oxide (CaO) 3%, alumina (Al2O3) 4˜5%, iron oxide (Fe2O3) 14.8˜15%, potassium oxide (K2O) 3˜3.5%, magnesium oxide (MgO) 1%, titanium dioxide (TiO2) 1˜1.5%, pulverized fuel ash 14˜15%, raw carbon powder 5%, cerium oxide (CeO2) 0.6˜0.7%, and lanthanum oxide (La2O3) 0.1%; the composition is mixed, positioned and shaped, and then calcined at high temperature to form a porous structure, and the far-infrared emissivity of the porous structure is more than 94%.

3. The Modular planting material for natural turf in sports field and its manufacturing process as claimed in claim 1, wherein the rice husk has components including nitrogen, phosphorus, potassium, calcium, magnesium, and silicon; and the oil millet husk has components including fat, protein, zinc, calcium, magnesium, potassium, and amino acids; and the oil millet stalk has components including lignocellulose and fatty acids.

4. The Modular planting material for natural turf in sports field and its manufacturing process as claimed in claim 1, the manufacturing method of the far-infrared mineral substrate is completed through the following steps according to the composition ratio of the far-infrared mineral substrate, including:
a) Preliminary screening: Preliminary screening of the raw materials of the mineral soil of the composition;
b) Crushing: Crushing equipment is used to make the mineral material of the composition into powder;
c) Screening: Use screening equipment to screen the above-mentioned powders to a suitable particle size;
d) Composition preparation: Prepare the composition of the appropriate particle size according to the required ratio;
e) Proportional mixing: Use mixing equipment to stir the composition to form a mixture;
f) Positioning and shaping: Use shaping equipment to press the above-mentioned mixture to form a blank;
g) Precise calcination: Use a calcination furnace to heat the above-mentioned blank to a temperature of 1000˜1360° C., so that the sticky effect of the aluminum element is eliminated, thereby forming a porous structure;
h) High-energy test: Use test equipment to measure the above-mentioned porous structure to ensure that it has a pore size of 0.2˜0.8 microns, PH6.5˜8.5, density 0.4˜0.6 g/ml, specific surface area 80˜100 M²/g, and the far-infrared emissivity is above 86%;
i) Classification and crushing: Use crushing equipment to make the porous structure which passed the test into powder; and
j) Nano-grinding: Use dry-type nano-grinding equipment to grind the above-mentioned powders into specifications (0.85 mm to nanometer level) required for multiple applications, and make multiple high-efficiency far-infrared mineral substrates to further provide back-end as a raw material for soil improvement.

5. The Modular planting material for natural turf in sports field and its manufacturing process as claimed in claim 1, wherein the manufacturing method of the multi-biochar is completed by the following steps according to the composition ratio of the multi-biochar, including:
a) Vibration feeding and screening: Use vibration equipment and screen to screen the composition, and stir the composition according to the required ratio to form a mixture;
b) Preheating: Use a preheating device to raise the mixture to a temperature of 100˜120° C. and dry it to ensure the uniformity of quality;
c) Fumigation and pyrolysis: Use a rotary sintering furnace to further heat the mixture to a temperature of 250˜700° C. to avoid extreme carbonization that change its due physical, chemical, and biological diversification effects;
d) Cooling: Place the mixture in the air to cool it down to room temperature; and
e) Crushing, grinding, and classifying: Use crushing equipment to make the above-mentioned mixture at room temperature into powder, and use grinding equipment to grind the powder, and then classifying different specifications of multi-biochar finished product with different mesh screens.

6. The Modular planting material for natural turf in sports field and its manufacturing process as claimed in claim 1, the manufacturing method is to complete the 75-85% far-infrared mineral substrate, 10-20% multi-biochar, and 2-5% polysaccharide polymer through the following steps, including:
a) Stirring and conveying: Mix the aforementioned three materials according to their proportions, and use a stirring tank to fully stir, and then convey the mixture to the next process with a conveyor belt;
b) Drying: Use a hot air stove to dry the aforementioned mixture;
c) Pressing and shaping: Put the aforementioned dried mixture in a mold and heat it to a temperature of 80° C., then press and shape it to form a semi-finished product;
d) Sterilization and molding: Use a dry stove to heat the semi-finished product after pressing to a temperature of 100° C. for high-temperature sterilization and molding, so that the semi-finished product achieves uniformity, water retention, and stability;
e) Cooling and pressing: Place the aforementioned sterilized and formed semi-finished product in the air to cool it to room temperature, and apply a mold for pressing to form a finished product; and
f) Cutting: Use a cutting machine to cut the aforementioned finished product into modular planting materials.
